(19) United States
(12) Patent Application Publication
(10) Pub. No.: US 2022/0277402 A1
(43) Pub. Date: Sep. 1, 2022

(54) USER LOCATION CALCULATION APPARATUS AND METHOD, AND COMPUTER-READABLE MEDIUM

(71) Applicant: NEC Corporation, Minato-ku, Tokyo (JP)

(72) Inventors: Keisuke IKEDA, Tokyo (JP); Kazufumi KOJIMA, Tokyo (JP); Masahiro TANI, Tokyo (JP)

(73) Assignee: NEC Corporation, Minato-ku, Tokyo (JP)

(21) Appl. No.: 17/632,981

(22) PCT Filed: Aug. 9, 2019
(86) PCT No.: PCT/JP2019/031721

§ 371 Date: Feb. 4, 2022

(51) Int. Cl. G06Q 50/00

(52) U.S. Cl. CPC G06Q 50/01

(57) ABSTRACT

Estimation of the range of activities of a target user is enabled in a relatively narrow range. A target user whose location is to be calculated has an account in social media. An offline friend determination means (111) calculates an offline friendship level on the basis of friend information obtained from at least one social media account related to the target user. The offline friendship level is the degree of friendship in real space between the target user and the at least one social media account related to the target user. A friend weight calculation means (112) calculates a weight to be assigned to the friend information on the basis of the offline friendship level. A candidate location score calculation means (113) calculates a score representing the possibility of the target user being active at a candidate location on the basis of the friend information and the corresponding weight.

### TECHNICAL FIELD

The present disclosure relates to a user location calculation apparatus and method, an activity range estimation apparatus and method, and a computer-readable medium.

### BACKGROUND ART

Techniques of estimating the range of activities of a user who uses social media or a user who has an account in social media are known. As one of such estimation techniques, a technique of estimating the range (or a part of the range) of activities of a user by using residence place information of a “friend” on social media is known (for example, see Non Patent Literature 1 and Non Patent Literature 2). The “friend” indicates an account that is on social media which is the same as or different from a social media used by a target user and that is friending (including following) the target user. Further, the “friend” indicates an account having a companionship with the target user, such as having exchanged messages. A friend account is operated by a person, an organization or the like. The “range of activities” indicates an area in which a user appears on a routine basis, such as a user's place of residence or place of work, stores which the user visits for shopping, eating and the like, and routes between them.

As related art, Patent Literature 1 discloses an information processing system that provides a user with information about real-estate properties. In the system disclosed in Patent Literature 1, an application server acquires user data related to a target user from an SNS (Social Networking Service) server. The user data contains online activities of the target user in SNS and online activities of other users (friends, followers etc. of the target user) related to the target user. For example, the application server acquires information such as location information of the user, a place of residence of the user, location information of friends, places of residence of friends and the like from the SNS server.

The application server analyzes the user data acquired from the SNS server, and acquires places related to the user and user attributes that affect the user's selection of a property. The application server also analyzes posted information and profiles of other users related to the target user, and acquires information about these other users also. The user attributes acquired by the application server contain the places of activities of other users associated with the target user, the places of visit where the user visits at a predetermined frequency or higher, and the moving routes of the user. The application server acquires places relevant to the user attributes, and further acquires property attributes relevant to the user attributes. The application server searches a property information database on the basis of the acquired places and property attributes, and acquires property information to be provided to the user.

### CITATION LIST

### Patent Literature

Patent Literature 1: Japanese Unexamined Patent Application Publication No. 2013-214123

### Non Patent Literature

Non Patent Literature 1: Backstrom Lars, Eric Sun, and Cameron Marlow, “Find me if you can: improving geographical prediction with social and spatial proximity”, Proceedings of the 19th international conference on World Wide Web, 2010, pp. 61-70
Non Patent Literature 2: Liu Zhi and Yan Huang, “Closeness and structure of friends help to estimate user locations”, International Conference on Database Systems for Advanced Applications, Springer, pp. 33-48

### SUMMARY OF INVENTION

### Technical Problem

There is no spatial restriction to interaction between social media users, and each user is able to interact with people all over the world and become friends. In Non Patent Literature 1, the place of residence of the target user is estimated by using the places of residence of friends on social media. Thus, in Non Patent Literature 1, information of friends who have no relationship in real space is used to estimate the place of residence of the target user. Therefore, a range where the estimation is done is an enormous range exceeding a city or ward in Non Patent Literature 1

In Non Patent Literature 2, when estimating the place of residence, information of a friend is weighted according to the percentage of friends living in the same place and whether there is a friendship between the friends living in the same place. However, even if the percentage of friends living in the same place is high, the estimation target user is not always likely to live in this place.

For example, in the case where the estimation target user is an enthusiastic fan of a certain idol group, friends can be only social media accounts that are run by members and related persons of this idol group. Such an example is sufficiently possible with a social media account, called “hobby account” etc., limited to a specific use, which is created and run for the purpose of enjoying a hobby. In this case, it is likely that friends of the estimation target user are the members and the related persons of this idol group, and friend information obtained from such accounts are concentrated in a specific area. Further, the accounts of each member and each related person are likely to be friends of each other on social media. This can be easily assumed from the fact that the members and the related persons carry out activities together on a daily basis. According to the weighting method described in Non Patent Literature 2, weights are assigned according to whether the locations of activities of friends of a friend overlap and whether there is a link between friends of a friend whose locations of activities overlap. In this case, it is difficult to estimate the range of activities of the estimation target user in a narrow range and with high accuracy.

In Patent Literature 1, the places of activities of other users are acquired when providing property information. However, Patent Literature 1 fails to disclose that the range of activities of the target user is acquired from the ranges of activities of other users.

In view of the above circumstances, an object of the present disclosure is to provide a user location calculation apparatus and method, an activity range estimation apparatus and method, and a computer-readable medium that enable estimation of the range of activities of a target user in a relatively narrow range by using information about other users related to the target user.

### Solution to Problem

In order to achieve the above object, according to a first aspect of the present disclosure, there is provided a user location calculation apparatus including an offline friend determination means configured to calculate an offline friend level on the basis of first information obtained from at least one social media account related to a target user having an account in social media, the offline friend level indicating a degree of friendship in real space between the target user and the at least one social media account related to the target user; a weight calculation means configured to calculate a weight to be assigned to the first information on the basis of the offline friend level; and a candidate location score calculation means configured to calculate a score representing possibility of the target user being active at a candidate location on the basis of the first information and the weight.

According to a second aspect of the present disclosure, there is provided an activity range estimation apparatus including an offline friend determination means configured to calculate an offline friend level on the basis of information obtained from at least one social media account related to a target user having an account in social media, the offline friend level indicating a degree of friendship in real space between the target user and the at least one social media account; a weight calculation means configured to calculate a weight to be assigned to the information by using the offline friend level; a candidate location score calculation means configured to calculate a score representing possibility of the target user being active at a candidate location on the basis of the information and the weight; and an activity range estimation means configured to estimate an activity range of the target user on the basis of the score.

According to a third aspect of the present disclosure, there is provided a user location calculation method including calculating an offline friend level on the basis of information obtained from at least one social media account related to a target user having an account in social media, the offline friend level indicating a degree of friendship in real space between the target user and the at least one social media account; calculating a weight to be assigned to the information by using the offline friend level; and calculating a score representing possibility of the target user being active at a candidate location on the basis of the information and the weight.

According to a fourth aspect of the present disclosure, there is provided an activity range estimation method including calculating an offline friend level on the basis of information obtained from at least one social media account related to a target user having an account in social media, the offline friend level indicating a degree of friendship in real space between the target user and the at least one social media account; calculating a weight to be assigned to the information by using the offline friend level; calculating a score representing possibility of the target user being active at a candidate location on the basis of the information and the weight; and estimating an activity range of the target user on the basis of the score.

According to a fifth aspect of the present disclosure, there is provided a computer-readable medium storing a program causing a computer to perform a process including calculating an offline friend level on the basis of information obtained from at least one social media account related to a target user having an account in social media, the offline friend level indicating a degree of friendship in real space between the target user and the at least one social media account; calculating a weight to be assigned to the information by using the offline friend level; and calculating a score representing possibility of the target user being active at a candidate location on the basis of the information and the weight.

According to a sixth aspect of the present disclosure, there is provided a computer-readable medium storing a program causing a computer to perform a process including calculating an offline friend level on the basis of information obtained from at least one social media account related to a target user having an account in social media, the offline friend level indicating a degree of friendship in real space between the target user and the at least one social media account; calculating a weight to be assigned to the information by using the offline friend level; calculating a score representing possibility of the target user being active at a candidate location on the basis of the information and the weight; and estimating an activity range of the target user on the basis of the score.

### Advantageous Effects of Invention

The user location calculation apparatus and method, the activity range estimation apparatus and method, and the computer-readable medium according to the present disclosure enable estimation of the range of activities of a target user in a relatively narrow range by using information about other users related to the target user.

### BRIEF DESCRIPTION OF DRAWINGS

FIG. 1 is a block diagram showing a user location calculation apparatus according to a first example embodiment of the present disclosure.

FIG. 2 is a view showing a specific example of determination of a local account.

FIG. 3 is a view showing a specific example of local account determination using information about friends of a friend.

FIG. 4 is a view showing a specific example of offline friend determination based on overlap of the range of activities.

FIG. 5 is a flowchart showing an operation procedure of the user location calculation apparatus.

FIG. 6 is a block diagram showing a user location calculation apparatus according to a second example embodiment of the present disclosure.

FIG. 7 is a flowchart showing an operation procedure of the user location calculation apparatus.

FIG. 8 is a block diagram showing an activity range estimation apparatus according to a third example embodiment of the present disclosure.

FIG. 9 is a flowchart showing an operation procedure of the activity range estimation apparatus.

FIG. 10 is a block diagram showing an activity range estimation apparatus according to a fourth example embodiment of the present disclosure.

FIG. 11 is a flowchart showing an operation procedure of the activity range estimation apparatus.

FIG. 12 is a block diagram showing a configuration example of a computer device.

### DESCRIPTION OF EMBODIMENTS

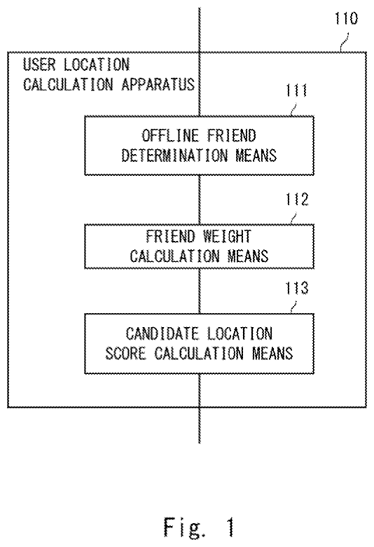

Example embodiments of the present disclosure will be described hereinafter in detail with reference to the drawings. FIG. 1 shows a user location calculation apparatus according to a first example embodiment of the present disclosure. A user location calculation apparatus 110 includes an offline friend determination means 111, a friend weight calculation means 112, and a candidate location score calculation means 113. The user location calculation apparatus 110 calculates the location of a user who has an account on social media. The user location calculation apparatus 110 calculates the location of a target user by using information (first information) about another user related to the target user on social media.

“Another user related to the target user on social media” indicates a user who has an account in social media and interacts with the target user in cyberspace (online). In this example embodiment, first information (friend information) obtained from a social media account of another user who is a friend in cyberspace is used. The friend information contains profile information obtained from an account of a friend of the target user, for example. The friend information may contain any information that allows acquiring the range of activities of this friend directly or indirectly from all data containing a posting history or the like obtained from a friend account. Further, the friend information may contain any information that allows determining the relationship between the target user and this friend directly or indirectly. The friend information can be provided from a user of the user location calculation apparatus, the target user or his/her friend, or a social media operating company. The friend information may be provided from a third party. These are just examples, and other information may be used as the friend information.

The friend information of the target user is input to the offline friend determination means 111 from an input device or the like, which is not shown. The offline friend determination means 111 calculates an offline friend level that represents whether a friendship between a friend and the target user is formed also in real space (offline). The offline friend level is represented by a binary value indicating whether it is an offline friend or not, for example. For example, the offline friend determination means 111 calculates a score indicating the degree of offline friend for each account of a friend of the target user. When the score exceeds a predetermined threshold, for example, the offline friend determination means 111 sets the offline friend level to a value (e.g., “1”) indicating that it is an offline friend. When the score is below the threshold, the offline friend determination means 111 sets the offline friend level to a value (e.g., “0”) indicating that it is not an offline friend. The threshold is set by a user of the user location calculation apparatus 110 as desired, for example.

An account of social media indicates an account that is opened by a user to use this social media. A social media operating company, a system, another user and the like can individually identify a user by using the account. An operating entity of an account may be an individual, or an organization or group such as a company or public office. There are cases where an organization or group such as a company or public office creates and operates a plurality of social media accounts according to departments or purposes. Specific examples of accounts operated by a company and a public office include the official Twitter (registered trademark) account (@NEC_jp_pr) of NEC Corporation, a Twitter account (@cao_japan) of the Cabinet Office, and so on.

In this example embodiment, the offline friend determination means 111 determines whether a friend account of the target user is a local account or not. The “local account” indicates an account related to a specific area. For example, the local account indicates an account of social media operated by targeting at a specific place or area among social media accounts. Examples of the local account are accounts operated by community-based companies such as a local newspaper, a local government, and a family-owned eatery. A specific example of the local account includes a Twitter account (@kawasaki_asaoku) of Kawasaki Asao Ward Office in Kanagawa.

Information obtained from the local account is information peculiar to this land, and a user who forms a companionship with the local account is considered to be a user who carries out activities in that area and wants information of the area. Thus, a user who is a friend of the local account is possibly carrying out activities in the area where this local account is active. When an account of a friend of the target user is a local account, this local account can be regarded as an important information source for estimating the range of activities of the target user. In this example embodiment, the offline friend determination means 111 may calculate the offline friend level of a friend on the basis of a determination result as to whether the friend account is a local account or not.

The determination as to whether the friend account is a local account can be made in the following procedure, for example. The offline friend determination means 111 refers to friend information and calculates a score according to whether there is information indicating that this account is operated by targeting at a specific place or area and the amount of such information. For example, the offline friend determination means 111 determines whether the friend information contains text such as “A City Hall Official”, a description such as “This is an account that mainly provides information about the city A” and the like by using text analysis. In the case where the friend information is a video, the offline friend determination means 111 determines whether the video of the friend information contains letters and voice such as “long-established taste with 100 years of history” and “local favorite with long history” by using video analysis technology. Note that these examples are by way of illustration only, and the present disclosure is not limited to the above techniques.

Instead of or in addition to the above, the offline friend determination means 111 may create a list of local companies and stores in advance and determine whether a friend account is a local account or not by using this list. Local stores and companies can be shown as a list of stores that are members of the chamber of commerce on HP (Home Page) of the corresponding local government or chamber of commerce, a local magazine and the like. Further, local stores and companies can be in a guide magazine as local long-established companies, or an article introducing them can be in a guide magazine. Those information are collected from websites or entered by hand and then registered in a list. The offline friend determination means 111 may determine whether a friend account is a local account or not by checking whether the friend account is in this list.

The offline friend determination means 111 may calculate the offline friend level according to an administrative level of an area which each friend account targets at. The range of the area which a local account targets at is considered to be different depending on the government level. For example, official accounts of local governments are intended to provide information to a city and ward level. On the other hand, the target area of official accounts of prefectural governments is at a prefecture level, which is larger than the target area of official accounts of local governments. Likewise, the target area of official accounts of national institutions, major companies and the like is the whole country. For example, the offline friend determination means 111 may set the offline friend level of an official account of a local government with a small target area to a large value (e.g., “1”). The offline friend determination means 111 may set the offline friend level of an account targeting at a prefecture level to an intermediate value (e.g., “0.7”). The offline friend determination means 111 may set the offline friend level of an account targeting at a country level to a small value (e.g., “0.2”). The above examples are by way of illustration only, and the value of the offline friend level according to the government level can be set by a user as desired.

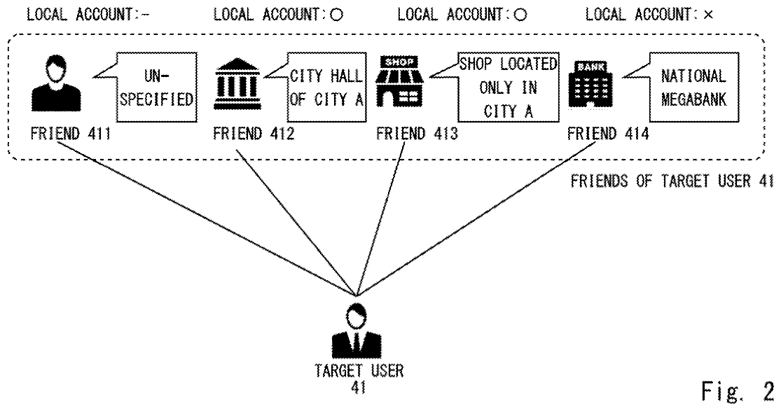

FIG. 2 is a view showing a specific example of determination of a local account. In FIG. 2, a target user 41 has total four friends 411 to 414 as friends on social media. The offline friend determination means 111 determines whether the accounts of the friends 411 to 414 are local accounts or not, and determines the offline friend level. The offline friend determination means 111 may determine whether accounts of friends in all social media in which the target user 41 has accounts are local accounts or not. For collection and identity determination of social media accounts of the target user 41, profile information, posted information and the like published by the accounts of the target user 41 can be used, for example.

The offline friend determination means 111 determines whether each friend is a local account or not on the basis of friend information of the friends 411 to 414. For the friend 411, the offline friend determination means 111 is unable to obtain sufficient information to determine whether it is a local account or not from the friend information. The case where sufficient information is not obtainable is, for example, when a profile is not open to public, when a profile is open to public but information on the profile does not contain any text to determine that it is a local account, and so on. When sufficient information is not obtainable, the offline friend determination means 111 determines that it is unclear whether the account of the friend 411 is a local account or not.

For the friend 412, the offline friend determination means 111 finds the description “city hall of the city A” in friend information (profile information). In this case, the offline friend determination means 111 determines that the account of the friend 412 is a local account since the account of the friend 412 is an account related to the city hall of the city A.

For the friend 413, the offline friend determination means 111 determines that the account of the friend 413 is an account related to the shop running only in the city A on the basis of information written in the profile information. The offline friend determination means 111 determines that the friend 413 is a shop that is located in the city A and has no sister store on the basis of store information written in the profile information, for example. Alternatively, the offline friend determination means 111 determines that the friend 413 is a shop that is run only in the city A. When a URL (Uniform Source Locator) of the shop is written in the profile information, the offline friend determination means 111 may access a linked page from this URL and check whether the shop is located in the city A and has no sister store, or whether it is a shop run only in the city A. When it is determined that the friend 413 is a person related to the shop that is run only in the city A, the offline friend determination means 111 may determine that the account of the friend 413 is a local account.

For the friend 414, the offline friend determination means 111 determines that the account of the friend 414 is an account of a megabank that has branch offices all over the country on the basis of information written in the profile information. For example, when the profile information contains the description that it is an official account of a megabank, the offline friend determination means 111 determines that the account of the friend 414 is an account of the megabank. In this case, the offline friend determination means 111 determines that the account of the friend 414 is not a local account.

The offline friend determination means 111 determines that the friend 412 and the friend 413 (the accounts of them) are local accounts in the example of FIG. 2. In this case, the offline friend determination means 111 determines that the friend 412 and the friend 413 determined to be local accounts are offline friends. For the friend 411, the offline friend determination means 111 determines that it is unclear whether the friend 411 is an offline friend or not. The offline friend determination means 111 determines that the friend 414 is not an offline friend.

When the offline friend determination means 111 determines that it is unclear whether the friend account is a local account or not, it may refer to friend's friend information (second information) of this friend account and determine whether the friend account is a local account or not. Assume, for example, that the offline friend determination means 111 is unable to determine, from information of a friend of the target user, that an account of this friend is a local account or that it is not a local account. In this case, the offline friend determination means 111 refers to information of a friend of this friend, and determines whether the account of the friend's friend is a local account or not. The offline friend determination means 111 may determine whether the account of the friend of the target user is a local account or not on the basis of the determination result as to whether the account of the friend's friend is a local account or not.

To be specific, the offline friend determination means 111 determines whether an account is a local account or not for each friend of a friend account where it is unclear whether it is a local account or not. Determination as to whether a friend's friend account is a local account or not may be the same as determination as to whether a friend account of the target user is a local account or not. The offline friend determination means 111 checks whether the area in which the friend's friend accounts determined to be local accounts are active are spatially dispersed. When the areas in which those local accounts are active are not spatially dispersed, the friend account of the target user is defined as a local account. When the areas in which those local accounts are active are not spatially dispersed, the offline friend determination means 111 may determine that the friend account is a local account. The offline friend determination means 111 may calculate the proportion of the friends of the friend account within the range of spatial dispersion as the offline friend level.

The state of being “spatially dispersed” indicates that friend accounts being local accounts are geographically distant. When the geographical distance between friend accounts being local accounts exceeds a threshold, the offline friend determination means 111 may determine that the areas in which those local accounts are active are spatially dispersed. For example, when the geographical distance between friend accounts being local accounts is within the threshold, the offline friend determination means 111 determines that the areas in which those local accounts are active are not spatially dispersed. The threshold may be set by a user of the user location calculation apparatus 110 as desired, for example. Alternatively, the geographical distance that ceases to be useful for estimation of the range of activities may be calculated in advance by data analysis, and this distance may be used as the threshold.

Note that the offline friend determination means 111 may exclude a friend's friend account whose location information is not known from calculation of the offline friend level. When there is only one friend's friend, a user of the user location calculation apparatus 110 may determine whether the friend of the target user is set as an offline friend or not.

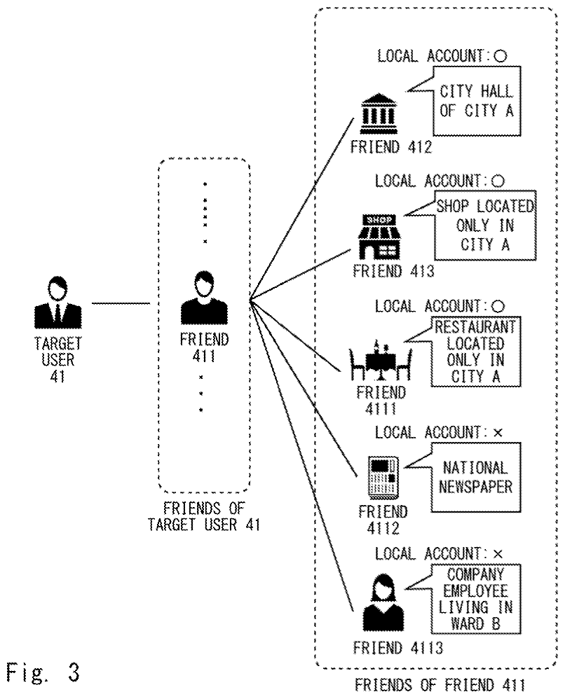

FIG. 3 is a view showing a specific example of local account determination using information about friends of a friend. Whether the friend 411 of the target user 41 is a local account or not is determined to be unclear in FIG. 2. The friend 411 has the friends 412, 413, and 4111 to 4113. The friends 412 and 413 are direct friends of the target user 41 (see FIG. 2), and they are already determined to be local accounts. The offline friend determination means 111 determines whether each of the friends 4111 to 4113 is a local account or not.

The offline friend determination means 111 refers to the friend information of the friend 4111, and determines that the friend 4111 is an account of a restaurant that is run only in the city A from the profile information or the like. Further, the offline friend determination means 111 refers to the friend information of the friend 4112, and determines that the friend 4112 is an account of a national newspaper from the profile information or the like. The offline friend determination means 111 refers to the friend information of the friend 4113, and determines that the friend 4113 is an account of a company employee who lives in the ward B from the profile information or the like. As a result, the offline friend determination means 111 determines that the friend 4111 is a local account and that the friends 4112 and 4113 are not local accounts.

A local account indicates a social media account that is operated by targeting at a specific place or area. Thus, it can be determined from the friend information or the like which place or area the local account is related to. In FIG. 3, all of the friends 412, 413 and 4111 that are local accounts are local accounts related to the city A. In this case, the offline friend determination means 111 determines that those local accounts are not spatially dispersed, and thereby determines that the friend 411 of the target user 41 is an offline friend. In the example of FIG. 3, three out of the five friends of the friend 411 are in the same city (city A). In this case, the offline friend determination means 111 may calculate the offline friend level of the friend 411 of the target user 41 to be 3/5.

In the above-described example, the offline friend determination means 111 determines whether a friend of the target user is an offline friend or not depending on whether the friend of the target user or the friend's friend of the target user is a local account or not. In this example embodiment, it may be determined whether a friend of the target user is an offline friend or not by using the following technique instead of or in addition to the above example.

The range of behavior in which a person can move on a daily basis is limited to a certain space. If the range of behavior overlaps between friends, the friends possibly interact in real space also. Thus, the friends with the overlapping range of behavior are likely to be friends in real space also. Stated differently, the friends whose range of activities is an area in which the range of activities of each friend account overlaps are determined to be offline friends.

Regarding friends of the target user whose ranges of activities are known, the offline friend determination means 111 puts the friends whose ranges of activities at least partly overlap into a group. Stated differently, the offline friend determination means 111 classifies the friends of the target user into one or more groups (friend cluster) on the basis of the overlap of the range of activities of the friends of the target user. Examples of a technique of classifying into a friend cluster include DBSCAN (Density-based spatial clustering of applications with noise), K-means and the like. A technique of clustering is not particularly limited. The offline friend determination means 111 determines that all of friends belonging to each friend cluster formed by clustering are offline friends. The offline friend determination means 111 excludes a friend whose range of activities is unclear from forming a friend cluster.

Further, as another technique of the offline friend determination based on the range of behavior of a person, the offline friend determination means 111 calculates the proportion of friends belonging to each cluster to the number of the target user's friends whose ranges of activities are known. If the proportion of friends belonging to each cluster to the friends of the target user is high, the friends belonging to the cluster possibly form a friendship with the target user in real space. Thus, the offline friend determination means 111 determines that the friends belonging to the cluster where the proportion of the friends belonging thereto to the target user's friends whose ranges of activities are known is a certain value or higher are offline friends of the target user.

In the method described in Non Patent Literature 2, attention is focused only on a single area. On the other hand, in the above-described offline friend determination based on the overlap of the area of activities, the overlap of the range of activities of each friend is taken into consideration. Thus, the above-described offline friend determination based on the overlap of the area of activities enables determination of friends who carry out activities in the adjacent area, differently from Non Patent Literature 2.

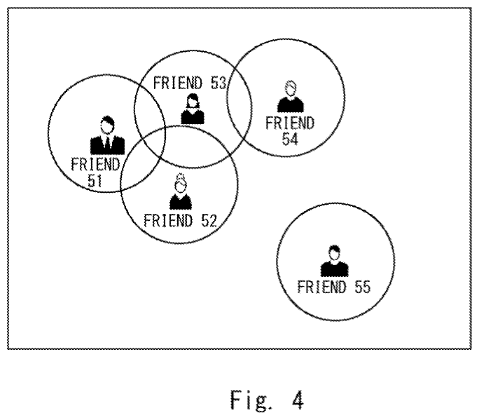

FIG. 4 shows a specific example of offline friend determination based on the overlap of the range of activities. In this example, friends of the target user are friends 51 to 55. It is assumed that the range of activities of each of the friends 51 to 55 is known. In FIG. 4, the range of activities of each friend is represented by a circle. The offline friend determination means 111 classifies the friends 51 to 55 into a plurality of groups (clusters) on the basis of the overlap of the range of activities. When a plurality of friends belong to the same cluster, those plurality of friends are considered to be offline friends.

The offline friend determination means 111 classifies the friend 51, the friend 52, and the friend 53 whose ranges of activities partly overlap into the same cluster. The friend 51, the friend 52, and the friend 53 who belong to this cluster are considered to be offline friends. Likewise, the offline friend determination means 111 classifies the friend 53 and the friend 54 whose ranges of activities partly overlap into the same cluster. The friend 53 and the friend 54 who belong to this cluster are determined to be offline friends. For the friend 55, there is no other friend whose range of activities overlaps. Thus, it is determined that the friend 55 is not an offline friend of any of the friends 51 to 54.

The offline friend determination means 111 determines whether the target user and a friend belonging to each cluster are offline friends or not on the basis of the proportion of the number of friends belonging to each cluster to the total number of friends of the target user, for example. The offline friend determination means 111 calculates the proportion of the number of friends belonging to each cluster to the total number of friends of the target user as the offline friend level of the friend belonging to each cluster.

The offline friend determination means 111 calculates the offline friend level of each of the friend 51, the friend 52, and the friend 53 who belong to the same cluster to be 3/5, for example. Further, the offline friend determination means 111 calculates the offline friend level of the friend 53 and the friend 54 who belong to the same cluster to be 2/5, for example. For the friend 53 who belongs to the two clusters, the offline friend determination means 111 calculates two offline friend levels. In this case, the offline friend determination means 111 may use either one of the two offline friend levels as the offline friend level of the friend 53. Alternatively, the offline friend determination means 111 may use the average of the two offline friend levels as the offline friend level of the friend 53. Which of the above two offline friend levels and the average is to be used may be determined by a user of the user location calculation apparatus 110

The offline friend determination means 111 calculates the offline friend level of the friend 55 to be 1/5 since there is no other friend belonging to the same cluster. In this case, the offline friend determination means 111 may determine that the friend 55 is not an offline friend of the target user because the calculated offline friend level is low.

Although the example in which friends whose ranges of activities directly overlap are classified into the same cluster is described above, a technique of forming a friend cluster is not limited thereto. The offline friend determination means 111 may classify friends whose ranges of activities directly or indirectly overlap into the same cluster. For example, in FIG. 4, the range of activities of the friend 53 partly overlaps the ranges of activities of the friend 51, the friend 52, and the friend 54. However, the range of activities of the friend 54 does not overlap the ranges of activities of the friend 51 and the friend 52. In this case, the offline friend determination means 111 may classify the friends 51 to 54 into the same cluster. This is because there is a possibility that the friend 54 interacts with the friend 51 and the friend 52 through the friend 53. In this case, the offline friend level of the friend 51, the friend 52, the friend 53, and the friend 54 is calculated to be 4/5. The above-described technique of clustering and calculation of the offline friend level are by way of illustration only, and they are not limited to the above examples.

Further, the offline friend determination means 111 may calculate the offline friend level on the basis of whether there is a friendship between friends of the target user. For example, the offline friend determination means 111 checks whether friends of a friend of the target user include another friend of the target user. When the target user and two friends of the target user are represented by points, and two points are connected by a line when there is a friendship, the offline friend determination means 111 checks whether a triangle with the target user and the two friends at vertices is formed or not. When the two friends of the target user have a friendship, the offline friend determination means 111 may determine that those two friends are offline friends. This is because when two persons who are friends of a certain user are friends of each other, those three persons possibly have a close relationship, and those three persons are likely to interact with one another in real space also. For example, the target user can meet another user who is a friend of one user through this one user who is a friend of the target user, and form a friendship with this another user. Such users who form a triangle can be regarded as offline friends. The offline friend determination means 111 may calculate the friend level of each offline friend on the basis of the proportion of the number of triangles to the combinations for selecting any two friends from all friends of the target user, for example. A technique of calculating the offline friend level is not particularly limited to the above example.

The above-described determination on an offline friend is described hereinafter by using a specific example. As shown in FIG. 2, the target user 41 has four friends 411 to 414. Further, as shown in FIG. 3, friends of the friend 411 include the friends 412 and 413. In this case, a triangle having the target user 41, the friend 411, and the friend 412 at vertices and a triangle having the target user 41, the friend 411, and the friend 413 at vertices are formed as a friendship of the target user and this user's friends. In this case, the offline friend determination means 111 determines that the target user 41 and the friends 411, 412 and 413 are offline friends.

The offline friend determination means 111 may determine not only whether friends of the target user have a friendship but also whether the ranges of activities of those friends at least partly overlap. For example, when friends of the target user have a friendship and their ranges of activities at least partly overlap, the offline friend determination means 111 may determine that the two friends of the target users are offline friends.

As another example, the offline friend determination means 111 may calculate the offline friend level of friends of the target user on the basis of whether a friend account of the target user is an account of a famous user such as a celebrity, for example. This is based on the assumption that a famous user and a general user rarely have a companionship in real life. When a friend account of the target user is an account of a famous user, the offline friend determination means 111 determines that this friend is not an offline friend. The offline friend determination based on whether it is an account of a famous user may be used alone or may be used in combination with at least one of the above-described local account determination and offline friend determination based on the overlap of the range of activities.

The offline friend determination means 111 determines whether a friend account of the target user is an account that is certified as a famous person by a social media operating company, for example. When the friend account is an account that is certified as a famous person, the offline friend determination means 111 determines that the friend account is an account of a famous person.

The offline friend determination means 111 may determine whether a friend account is an account of a famous person or not on the basis of information that the famous person acknowledged it as his/her account in public media such as a television or an official homepage, for example. Such information are collected from websites, for example, and provided to the offline friend determination means 111. Alternatively, such information may be provided from a company that archives websites and television programs.

The offline friend determination means 111 may count the number of friends of a friend account of the target user and determine whether the friend account is an account of a famous person or not on the basis of the number of friends. Generally, an account of a famous user has a large number of friends. The offline friend determination means 111 may determine that the friend account is an account of a famous user when the number of friends of the friend account is a certain value or more.

Further, in the case of social media that form a directed graph such as Twitter, for example, there can be a significant difference between the number of following and the number of followers in an account of a famous user. The offline friend determination means 111 may determine whether there is a significant difference between the number of following and the number of followers, and determine that the friend account is an account of a famous user when there is a significant difference.

The offline friend determination means 111 determines that the friend who is determined to be a famous user is not an offline friend. The offline friend determination means 111 may set the offline friend level of the friend determined to be a famous user to a value predetermined by a user of the user location calculation apparatus 110, for example. Note that the above-described technique of determining an account of a famous user is by way of illustration only, and the determination as to whether it is a famous user or not is not particularly limited to the above method.

The offline friend determination means 111 may calculate a reliability level for the offline friend level (determination result) in addition to the offline friend level. The reliability level indicates the degree of reliability of a determination result as an offline friend. For example, the reliability level is determined according to information or a technique used to determine an offline friend, for example. When it is determined that a friend of the target user is an offline friend on the basis of the friend information of the friend of the target user, for example, the offline friend determination means 111 determines that the reliability of this determination is high. On the other hand, when it is determined that a friend account is an offline friend on the basis of the friend information of a friend of the friend account, the offline friend determination means 111 determines that the reliability of this determination is low. This example is by way of illustration only, and a method of determining the reliability is not particularly limited.

The offline friend determination means 111 outputs the offline friend level and the reliability level for the offline friend determination to the friend weight calculation means 112. The friend weight calculation means (weight calculation means) 112 determines weighting for each friend information on the basis of the friend information of each friend of the target user, the offline friend level, and the reliability level. A weight indicates the degree of placing importance on the friend information. The friend weight calculation means 112 assigns a large weight to the friend information of a friend of the target user determined to be an offline friend, for example. The friend weight calculation means 112 assigns a small weight to the friend information of a friend of the target user determined not to be an offline friend, for example. The friend weight calculation means 112 may adjust a weight depending on the reliability level when determining a weight to be assigned.

As a specific example of weighting, determination of weights on the friends 411 to 414 shown in FIG. 2 is described hereinbelow. The friend weight calculation means 112 sets the weight to “2” in the case of being an offline friend, and sets the weight to “1” in the case of not being an offline friend, for example. Further, it is assumed that the offline friend determination means 111 sets the reliability level to “1” when a friend is determined to be an offline friend by using the friend information of this friend, and otherwise sets the reliability level to “0.8”.

The offline friend determination means 111 is unable to determine whether the friend 411 is an offline friend or not from information of this friend, and determines that the friend 411 is an offline friend by using information of a friend of this friend (see FIG. 3 also). In this case, the offline friend determination means 111 sets the reliability level for the determination result of an offline friend of the friend 411 to “0.8”. The friend weight calculation means 112 determines a weight on the friend 411 to be 2×0.8=1.6.

The offline friend determination means 111 determines that the friends 412 and 413 are offline friends from information of those friends. In this case, the offline friend determination means 111 sets the reliability level for the determination result of an offline friend of the friends 412 and 413 to “1”. In this case, the friend weight calculation means 112 determines a weight on the friends 412 and 413 to be “2”. For the friend 414, the offline friend determination means 111 determines that the friend 414 is not an offline friend from information of this friend. The offline friend determination means 111 sets the reliability level for the determination result of an offline friend of the friend 414 to “1”. In this case, the friend weight calculation means 112 determines a weight on the friend 414 to be “1”. This example is by way of illustration only, and calculation of a weight is not limited to the above.

The friend weight calculation means 112 outputs the weighted friend information to the candidate location score calculation means 113. The candidate location score calculation means 113 calculates a score representing the possibility of the target user being active at each candidate location on the basis of the weighted friend information. This score indicates the possibility that the target user carries out activities at each candidate location. The “candidate location” indicates a candidate for the space in which the target user is considered to be active. The candidate location is selected in advance by a user of the user location calculation apparatus 110, for example. Alternatively, the user location calculation apparatus 110 may select the candidate location from the locations of activities of friends of the target user. The candidate location may be selected by using the method described in Non Patent Literature 1 or Non Patent Literature 2. A method of selecting the candidate location is not particularly limited.

The candidate location score calculation means 113 calculates the distance between each candidate location and the location of activities of a friend of the target user, for example. The candidate location score calculation means 113 inputs the calculated distance to the model representing the relationship of the presence or absence of a friendship and the distance described in Non Patent Literature 1 and thereby calculates a score. The candidate location score calculation means 113 calculates the distance between each candidate location and the location of activities and calculates the score for all friends of the target user. In the calculation of the score, the candidate location score calculation means 113 increases or decreases the degree of placing importance on the friend information according to the weight of each friend calculated by the friend weight calculation means 112. As the weight is heavier, the candidate location score calculation means 113 calculates the score by placing more importance on this friend information. In other words, as the weight is heavier, the candidate location score calculation means 113 increases the effect of the friend information on the score calculation. The above-described method of calculating the score is by way of illustration only, and the candidate location score calculation means 113 may calculate the score representing the possibility of being active at each location by using a method different from the above.

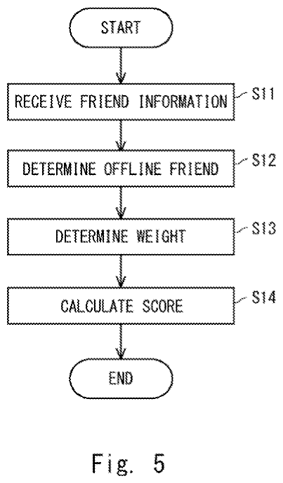

An operation procedure is described hereinafter. FIG. 5 shows an operation procedure (user location calculation method) of the user location calculation apparatus 110. The offline friend determination means 111 receives friend information of the target user from an input device, which is not shown (Step S11). The offline friend determination means 111 determines whether each friend of the target user is an offline friend or not by using the friend information (Step S12). Specifically, the offline friend determination means 111 determines whether each friend of the target user is a friend of the target user in real space also, or not a friend of the target user in real space. The offline friend determination means 111 outputs the offline friend level as a determination result of an offline friend and its reliability level to the friend weight calculation means 112.

The friend weight calculation means 112 determines a weight to be assigned to each friend (friend information) by using the offline friend level and its reliability level (Step S13). The friend weight calculation means 112 assigns a relatively large weight to the friend information of a friend determined to be an offline friend. On the other hand, the friend weight calculation means 112 assigns a relatively small weight to the friend information of a friend determined not to be an offline friend. The candidate location score calculation means 113 calculates the score for each of candidate activity locations of the target user on the basis of the friend information to which the weight determined in Step S13 is assigned (Step S14). The candidate location score calculation means 113 outputs a calculation result of the score of each candidate activity location to an output device, which is not shown.

As described in Non Patent Literature 1, persons at a short spatial distance are likely to become friends. Thus, another user who is spatially close and has a relationship in real life is considered to be included in friends on social media of the target user. In this example embodiment, the offline friend determination means 111 determines offline friends considered to have a friendship with the target user also in real life among friends of the target user that are possibly scattered all around the world. The friend weight calculation means 112 sets a weight on the friend information of an offline friend to be greater than a weight on the friend information of a friend that is not an offline friend. The candidate location score calculation means 113 calculates the score of each candidate activity location by using the weighted friend information.

In this example embodiment, the friend information of a friend of the target user is weighted depending on whether the friend is an offline friend. The spatial distance between the target user and an offline friend is considered to be closer than the spatial distance between the target user and a friend that is not an offline friend. Thus, it is considered that an offline friend can provide more useful location information for estimation of the range of activities of the target user compared with a friend that is not an offline friend. In this example embodiment, greater importance is given to the friend information of an offline friend in the calculation of the score of each candidate location. In this manner, calculating the score by giving greater importance to the friend information of an offline friend allows calculating the location of the target user in a narrower range.

In comparison with Non Patent Literatures 1 and 2, the presence or absence of a friendship in real space is not taken into consideration, and whether a friend of the target user is an offline friend is not determined in those literatures. In the related art including Non Patent Literatures 1 and 2, all of the friend information of the target user to be used for estimation of the range of activities are treated equally or weighted in an insufficient manner. Thus, in the related art, a target of estimation is an enormous range exceeding a city and ward level. In this example embodiment, the friend information is weighted on the basis of a determination result as to whether it is an offline friend, which allows calculating the location of the user by giving greater importance to the friend information of a friend having a friendship in real space and thereby allows calculating the location of the user in a narrow range.

An estimation result of the range of activities of a social media user in real space is used for sales promotion and customer analysis in the marketing field, for example. Further, an estimation result of the range of activities is used to acquire information about a person related to a crime that abuses cyberspace. For example, in the case where an estimation result is used for sales promotion of a product, if the estimation result is an enormous range, when sales promotion is carried out, there is a possibility that a store in promotion is distant from the actual activity range of the target user. In such a case, costs such as traveling time and traveling expenses are high, which can inhibit the target user from actually purchasing the product or the like. Further, in the case where an estimation result is used for criminal investigation, estimation in a range across a plurality of cities or wards can be outside the jurisdiction of the investigating authority, thus not contributing to investigation activities. As in those examples, use of a calculation result of the user location is limited in narrowing in an enormous range exceeding a city and ward level. This example embodiment enables calculation of the user location in a narrower range. Therefore, a calculation result of the user location is considered to be useful in applications to the marketing field and criminal investigation.

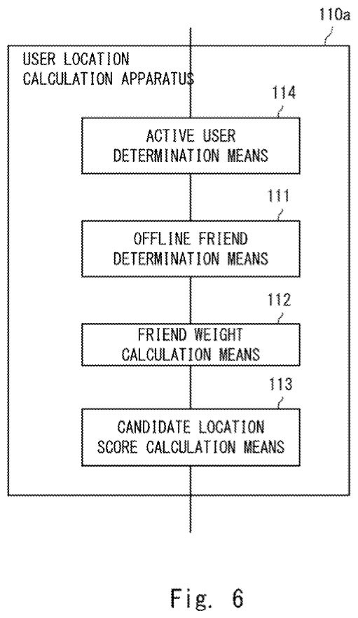

A second example embodiment of the present disclosure is described hereinafter. FIG. 6 shows a user location calculation apparatus according to the second example embodiment of the present disclosure. In this example embodiment, a user location calculation apparatus 110a includes an active user determination means 114 in addition to the components of the user location calculation apparatus 110 according to the first example embodiment shown in FIG. 1. The operations of the offline friend determination means 111, the friend weight calculation means 112, and the candidate location score calculation means 113 may be the same as the operation of those in the first example embodiment.

Friend information of the target user is input to the active user determination means 114 from an input device, which is not shown. The active user determination means 114 determines whether each of friends of the target user is an active user who is actively using social media or an inactive user. For example, the active user determination means 114 determines whether a friend is an active user or not on the basis of the frequency of posting of a user of the friend account. Alternatively, the active user determination means 114 may receive information about login of a user of the friend account and determine whether the friend is an active user or not on the basis of the interval of login. A method of determining an active user is not particularly limited, and the active user determination means 114 may determine whether a friend is an active user or not by a different method from the above example.

The active user determination means 114 outputs the friend information of a friend determined to be an active user among the friends of the target user to the offline friend determination means 111. The active user determination means 114 discards the friend information of a friend determined not to be an active user and does not output it to the offline friend determination means 111. The offline friend determination means 111 determines whether the friend determined to be an active user is an offline friend or not among the friends of the target user. The subsequent operation may be the same as the operation described in the first example embodiment.

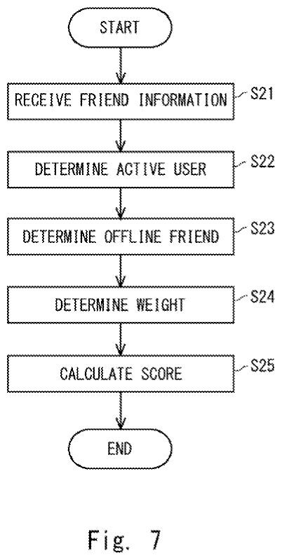

FIG. 7 shows an operation procedure of the user location calculation apparatus 110a according to this example embodiment. The active user determination means 114 receives friend information of the target user (Step S21). The active user determination means 114 determines whether each of the friends of the target user is an active user or not (Step S22). The active user determination means 114 outputs the friend information of a friend determined to be an active user to the offline friend determination means 111. The friend information of a friend determined not to be an active user is discarded in the active user determination means 114 and not used in the subsequent processing.

The offline friend determination means 111 determines whether each friend of the target user is an offline friend or not on the basis of the friend information of the friend who is an active user (Step S23). The friend weight calculation means 112 determines a weight to be assigned to each friend by using the offline friend level and its reliability level (Step S24). The candidate location score calculation means 113 calculates the score for each of candidate activity locations of the target user on the basis of the friend information to which the weight determined in Step S24 is assigned (Step S25). The operation in Steps S23 to S25 may be the same as the operation in Steps S12 to S14 in FIG. 5.

Non Patent Literature 2 has a problem that the acquisition costs for information to be used for estimation of the range of activities are high. The “acquisition costs” indicate a cost in terms of time due to restricted access to API (Application Programming Interface) for information acquisition of social media, a cost in terms of money charged when using the API, and so on. In social media, there are accounts with old information, such as accounts that are registered but left unused, and accounts that have been used in the past but not used currently. The old information obtained from such accounts can have adverse effects on a calculation result of the user location. Further, they can cause an unnecessary increase in acquisition costs since information not useful for calculation of the user location is acquired.

In this example embodiment, the active user determination means 114 determines whether a friend of the target user is an active user or not. The active user determination means 114 outputs the friend information of the friend who is an active user to the offline friend determination means 111. This allows a friend not using social media to be excluded from calculation of the location of the target user and thereby reduces the number of friends to be used for calculation of the location. Thus, this example embodiment enables reduction of data acquisition costs in terms of time and money. Further, since the location is calculated using relatively new information of active users rather than old information of inactive users, the location calculation in line with the current conditions is achieved.

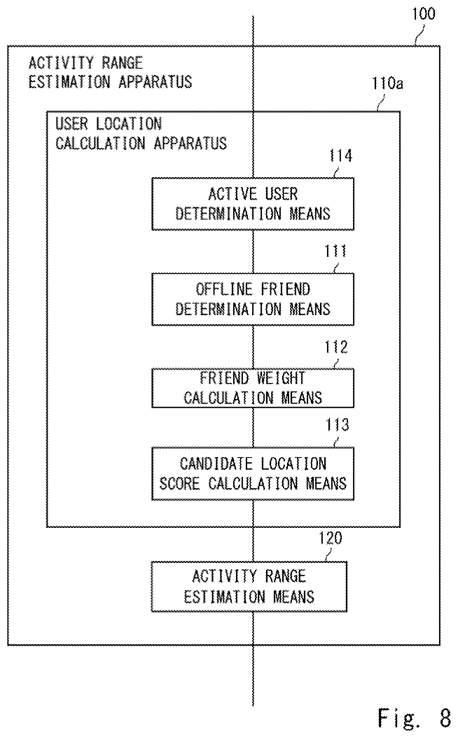

A third example embodiment of the present disclosure is described hereinafter. FIG. 8 shows an activity range estimation apparatus according to the third example embodiment of the present disclosure. In this example embodiment, an activity range estimation apparatus 100 includes an activity range estimation means 120 in addition to the components of the user location calculation apparatus 110a described in the second example embodiment shown in FIG. 6. The activity range estimation apparatus 100 may have a configuration that includes the activity range estimation means 120 in addition to the components of the user location calculation apparatus 110 described in the first example embodiment shown in FIG. 1.

The user location calculation apparatus 110a calculates the score for each of candidate activity locations of the target user and outputs the score of each candidate location to the activity range estimation means 120. The activity range estimation means 120 selects a candidate location on the basis of the score of each candidate location, and determines a range of activities related to the target user as desired.

The activity range estimation means 120 searches for a candidate location with the highest score, for example. The candidate location with the highest score is considered to correspond to a location in which the target user is based, such as a place of residence or a place of work of the target user. The activity range estimation means 120 selects the candidate location with the highest score as the range of activities of the user. In this case, the activity range estimation apparatus 100 is able to estimate the location in which the target user is based.

Alternatively, the activity range estimation means 120 may compare the score with a threshold, and select one or a plurality of candidate locations with the score equal to or higher than the threshold. The candidate location whose score is equal to or higher than the threshold is considered to correspond to a base location of the target user such as a place of residence and the range of movement of the target user in daily life. In this case, the activity range estimation apparatus 100 is able to estimate the location in which the target user is based and the range of movement in daily life.

A user can input the purpose of use of an estimation result of the range of activities of the target user or the like to the activity range estimation apparatus 100. According to the purpose of use or the like input by the user, the activity range estimation means 120 sets a candidate location with the highest score or a candidate location with the score equal to or higher than a threshold as the range of activities of the target user. This example is by way of illustration only, and a method of estimating the range of activities of the target user from the score of each candidate location in the activity range estimation means 120 is not limited to the above method.

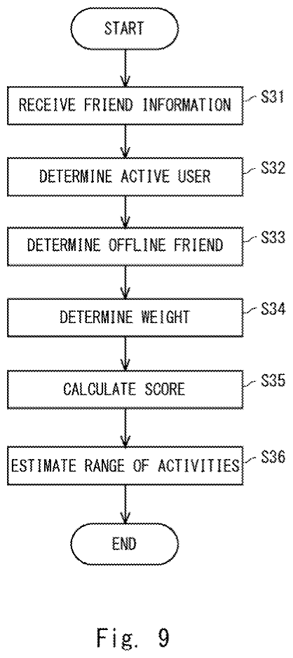

FIG. 9 shows an operation procedure (activity range estimation method) of the activity range estimation apparatus 100. The active user determination means 114 receives friend information of the target user (Step S31). The active user determination means 114 determines whether each of the friends of the target user is an active user or not (Step S32). The active user determination means 114 outputs the friend information of a friend determined to be an active user to the offline friend determination means 111.

The offline friend determination means 111 determines whether each friend of the target user is an offline friend or not on the basis of the friend information of the friend who is an active user (Step S33). The friend weight calculation means 112 determines a weight to be assigned to each friend by using the offline friend level and its reliability level (Step S34). The candidate location score calculation means 113 calculates the score for each of candidate activity locations of the target user on the basis of the friend information to which the weight determined in Step S34 is assigned (Step S35). The operation in Steps S31 to S35 may be the same as the operation in Steps S21 to S25 in FIG. 7.

The candidate location score calculation means 113 outputs the score of each candidate activity location of the target user to the activity range estimation means 120. The activity range estimation means 120 estimates the range of activities of the target user on the basis of the score of each candidate location (Step S36). A user can specify whether to estimate the base location of the target user or estimate the area where the target user carries out activities on a daily basis to the activity range estimation apparatus 100. The activity range estimation means 120 estimates the range of activities according to a request from the user in Step S36. The activity range estimation means 120 outputs an estimation result of the range of activities to an output device, which is not shown.

In this example embodiment, the activity range estimation means 120 estimates the range of activities of the target user by using the score of candidate locations of the activities of the target user output from the user location calculation apparatus 110a. For example, the activity range estimation means 120 estimates the range of activities of the target user by selecting and summarizing the score of each candidate location according to a request from a user of the activity range estimation apparatus 100. This example embodiment allows the user location calculation apparatus 110a to calculate the location of the target user in a narrow range. Thus, the activity range estimation apparatus 100 is able to estimate the range of activities of the target user in a narrow range.

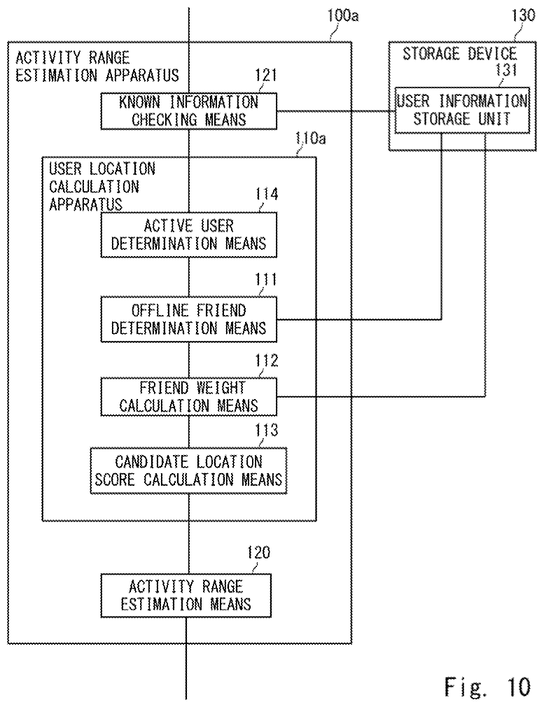

A fourth example embodiment of the present disclosure is described hereinafter. FIG. 10 shows an activity range estimation apparatus according to the fourth example embodiment of the present disclosure. In this example embodiment, an activity range estimation apparatus 100a includes a known information checking means 121 in addition to the components of the activity range estimation apparatus 100 described in the third example embodiment shown in FIG. 8. In the activity range estimation apparatus 100a, the user location calculation apparatus 110 described in the first example embodiment shown in FIG. 1 may be used in place of the user location calculation apparatus 110a.

In this example embodiment, a storage device 130 includes a user information storage unit 131. An auxiliary storage device such as a hard disk device, for example, is used as the storage device 130. The user information storage unit 131 stores known information containing friend information of friends of the target user and weights calculated by the friend weight calculation means 112. The known information may contain the offline friend level and its reliability level calculated by the offline friend determination means 111.

The known information checking means 121 checks whether the friend information of a friend of the target user is stored in the user information storage unit 131 or not. When the friend information of the friend of the target user is stored in the user information storage unit 131, the candidate location score calculation means 113 calculates a score by using the friend information and the weight read from the user information storage unit 131. In this case, the user location calculation apparatus 110a does not need to newly acquire the friend information. When, on the other hand, the friend information of the friend of the target user is not stored in the user information storage unit 131, the active user determination means 114 acquires the friend information and determines whether the friend of the target user is an active user or not.

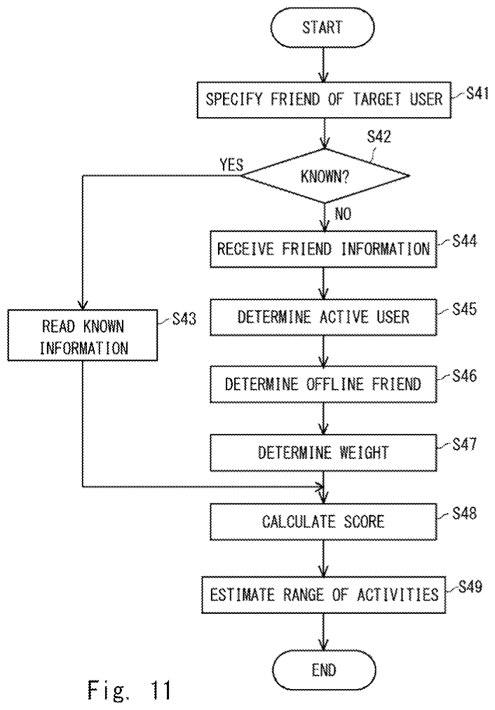

FIG. 11 shows an operation procedure of the activity range estimation apparatus 100a. Information that specifies a friend of the target user is input to the known information checking means 121 (Step S41). The known information checking means 121 determines whether the friend information of the friend of the target user is stored as the known information in the user information storage unit 131 or not (Step S42). When the friend information is stored, the known information checking means 121 causes the friend weight calculation means 112 to read the friend information and the weight from the user information storage unit 131 (Step S43).

On the other hand, when the friend information is not stored, the friend information of the target user is passed to the active user determination means 114. The active user determination means 114 receives the friend information of the target user (Step S44). The active user determination means 114 determines whether each of the friends of the target user is an active user or not (Step S45). The active user determination means 114 outputs the friend information of a friend determined to be an active user to the offline friend determination means 111. Further, the active user determination means 114 stores the friend information of a friend determined to be an active user into the user information storage unit 131.

The offline friend determination means 111 determines whether each friend of the target user is an offline friend or not on the basis of the friend information of the friend who is an active user (Step S46). The offline friend determination means 111 stores the offline friend level and its reliability level into the user information storage unit 131. The friend weight calculation means 112 determines a weight to be assigned to each friend by using the offline friend level and its reliability level (Step S47). The friend weight calculation means 112 stores the determined weight into the user information storage unit 131.

The candidate location score calculation means 113 calculates the score for each of candidate activity locations of the target user on the basis of the friend information to which the weight is assigned (Step S48). In Step S48, the candidate location score calculation means 113 calculates the score on the basis of the friend information and the weight read in Step S43. Alternatively, in Step S48, the candidate location score calculation means 113 calculates the score on the basis of the friend information received in Step S44 and the weight determined in Step S47. The activity range estimation means 120 estimates the range of activities of the target user on the basis of the score of each candidate location (Step S49). The operation in Steps S44 to S49 may be the same as the operation in Steps S32 to S36 in FIG. 9.

In this example embodiment, the known information checking means 121 checks whether the friend information and the corresponding weight are stored in the user information storage unit 131 or not. When the friend information and the corresponding weight are stored in the user information storage unit 131, determination on an active user and determination on an offline friend can be skipped in the user location calculation apparatus 110a. The friend information used for calculation of the user location, the offline friend level, the weight and the like are stored in the user information storage unit 131. By using the information stored in the user information storage unit 131, the user location can be calculated without need to collect the same friend information again from a social media operating company or the like. In many cases, a friend of a certain person is a friend of another person, too. By using the information stored in the user information storage unit 131, data acquisition costs of the friend information to be used for calculation of the user location are reduced in terms of time and money. Thus, this example embodiment achieves calculation of the user location with less information collection costs.

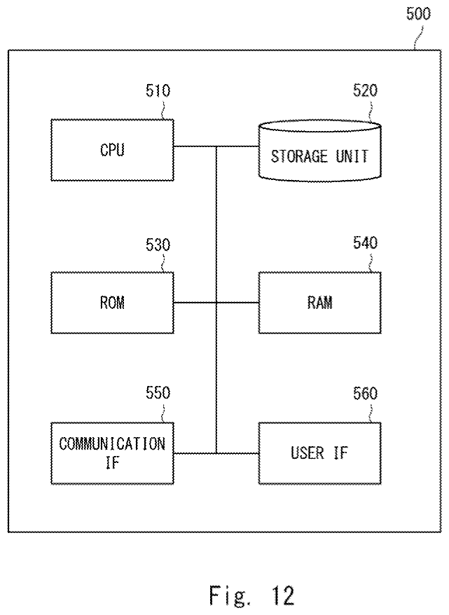

A physical configuration of the user location calculation apparatus and the activity range estimation apparatus is described hereinafter. FIG. 12 shows a configuration example of a computer device that can be used as the user location calculation apparatus 110 and the activity range estimation apparatus 100. A computer device 500 includes a control unit (CPU: Central Processing Unit) 510, a storage unit 520, a ROM (Read Only Memory) 530, a RAM (Random Access Memory) 540, a communication interface (IF: Interface) 550, and a user interface 560.

The communication interface 550 is an interface for connecting the computer device 500 and a communication network through a wired communication means, a wireless communication means or the like. The user interface 560 includes a display unit such as a display. The user interface 560 further includes an input unit such as a keyboard, a mouse, and a touch panel.

The storage unit 520 is an auxiliary storage device for storing various types of data. The storage unit 520 is not necessarily a part of the computer device 500, and it may be an external storage device or a cloud storage that is connected to the computer device 500 through a network. The storage unit 520 is used as the storage device 130 shown in FIG. 10, for example. The ROM 530 is a nonvolatile storage device. A semiconductor storage device such as a flash memory with relatively small capacity can be used for the ROM 530, for example. A program executed by the CPU 510 can be stored in the storage unit 520 or the ROM 530. The storage unit 520 or the ROM 530 stores various programs for implementing the functions of the elements of the user location calculation apparatus 110 and the elements of the activity range estimation apparatus 100, for example.

The above-described program can be stored using any type of non-transitory computer readable media and provided to the computer device 500. The non-transitory computer readable media include any type of tangible storage media. Examples of non-transitory computer readable media include magnetic storage media such as flexible disks, magnetic tapes or hard disks, optical magnetic storage media such as magneto-optical disks, optical disc media such as CD (Compact Disc) or DVD (Digital Versatile Disk), and semiconductor memories such as mask ROM, PROM (Programmable ROM), EPROM (Erasable PROM), flash ROM or RAM (Random Access Memory). The program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers, or a wireless communication line.

The RAM 540 is a volatile storage device. A semiconductor memory device such as DRAM (Dynamic Random Access Memory) or SRAM (Static Random Access Memory) is used as the RAM 540. The RAM 540 can be used as an internal buffer that temporarily stores data or the like. The CPU 510 develops, on the RAM 540, a program stored in the storage unit 520 or the ROM 530 and executes it. The CPU 510 executes the program, and thereby the functions of the elements of the user location calculation apparatus 110 and the elements of the activity range estimation apparatus 100 are implemented. The CPU 510 may include an internal buffer for temporarily storing data or the like.

While the present disclosure has been described in detail with reference to example embodiments thereof, the present disclosure is not limited to the above-described example embodiments, and various changes and modifications may be made therein without departing from the spirit and scope of the present disclosure.

For example, the whole or part of the example embodiments disclosed above can be described as, but not limited to, the following supplementary notes.

### [Supplementary Note 1]

A user location calculation apparatus comprising:

an offline friend determination means configured to calculate an offline friend level on the basis of first information obtained from at least one social media account related to a target user having an account in social media, the offline friend level indicating a degree of friendship in real space between the target user and the at least one social media account related to the target user;

a weight calculation means configured to calculate a weight to be assigned to the first information on the basis of the offline friend level; and

a candidate location score calculation means configured to calculate a score representing possibility of the target user being active at a candidate location on the basis of the first information and the weight.

### [Supplementary Note 2]

The user location calculation apparatus according to claim 1, wherein

the weight calculation means sets a value of the weight larger as the offline friend level increases, and

the candidate location score calculation means increases impact of the first information on calculation of the score as a value of the weight increases.

### [Supplementary Note 3]

The user location calculation apparatus according to claim 1 or 2, wherein the offline friend determination means determines whether the social media account related to the target user is a local account related to a specific area, and calculates the offline friend level on the basis of a result of the determination.

### [Supplementary Note 4]

The user location calculation apparatus according to claim 3, wherein when the offline friend determination means determines that it is unclear whether the social media account related to the target user is the local account, the offline friend determination means determines whether a social media account related to the social media account related to the target user is the local account on the basis of second information obtained from the social media account related to the social media account related to the target user, and determines whether the social media account related to the target user is the local account by using a result of the determination.

### [Supplementary Note 5]

The user location calculation apparatus according to claim 4, wherein the offline friend determination means determines that the social media account related to the target user is the local account on the basis of spatial dispersion of areas related to social media accounts related to the social media account determined to be the local account related to the target user.

### [Supplementary Note 6]

The user location calculation apparatus according to any one of claims 3 to 5, wherein the offline friend determination means calculates the offline friend level according to a government level of an area related to the local account.

### [Supplementary Note 7]

The user location calculation apparatus according to any one of claims 1 to 6, wherein the offline friend determination means calculates the offline friend level on the basis of an activity range of the social media account related to the target user.

### [Supplementary Note 8]

The user location calculation apparatus according to claim 7, wherein the offline friend determination means classifies social media accounts with known ranges of activities related to the target user into one or more clusters, and calculates the offline friend level according to a proportion of the number of social media accounts belonging to each cluster to the number of the social media accounts with the known ranges of activities related to the target user.

### [Supplementary Note 9]

The user location calculation apparatus according to any one of claims 1 to 6, wherein the offline friend determination means calculates the offline friend level on the basis of whether social media accounts related to the target user are related to each other.

### [Supplementary Note 10]

The user location calculation apparatus according to any one of claims 1 to 9, wherein the offline friend determination means determines whether a social media account related to the target user is a famous account, and calculates the offline friend level on the basis of a result of the determination.

### [Supplementary Note 11]

The user location calculation apparatus according to any one of claims 1 to 10, wherein

the offline friend determination means further calculates a reliability level of the offline friend level, and

the weight calculation means calculates the weight on the basis of the offline friend level and the reliability level.

### [Supplementary Note 12]

The user location calculation apparatus according to any one of claims 1 to 11, further comprising:

an active user determination means configured to determine whether a social media account related to the target user is an account of an active user,

wherein the offline friend determination means calculates the offline friend level of a social media account related to the target user determined to be an account of an active user by the active user determination means.

### [Supplementary Note 13]

The user location calculation apparatus according to any one of claims 1 to 12, further comprising:

a known information checking means configured to refer to a storage device storing the first information and the weight as known information, and determine whether information of a social media account related to the target user is stored in the storage device,

wherein when it is determined that information of the social media account related to the target user is stored in the storage device, the candidate location score calculation means calculates the score by using the first information and the weight read from the storage device.

### [Supplementary Note 14]

An activity range estimation apparatus comprising:

an offline friend determination means configured to calculate an offline friend level on the basis of information obtained from at least one social media account related to a target user having an account in social media, the offline friend level indicating a degree of friendship in real space between the at least one target user and the social media account;

a weight calculation means configured to calculate a weight to be assigned to the information by using the offline friend level;

a candidate location score calculation means configured to calculate a score representing possibility of the target user being active at a candidate location on the basis of the information and the weight; and

an activity range estimation means configured to estimate an activity range of the target user on the basis of the score.

### [Supplementary Note 15]

The activity range estimation apparatus according to claim 14, wherein

the candidate location score calculation means calculates the score for each of a plurality of candidate locations, and

the activity range estimation means estimates an activity range of the target user by selecting one or more candidate locations on the basis of a score of each candidate location.

### [Supplementary Note 16]

The activity range estimation apparatus according to claim 14 or 15, wherein

the weight calculation means sets a value of the weight larger as the offline friend level increases, and

the candidate location score calculation means increases impact of the information on calculation of the score as a value of the weight increases.

### [Supplementary Note 17]

A user location calculation method comprising:

calculating an offline friend level on the basis of information obtained from at least one social media account related to a target user having an account in social media, the offline friend level indicating a degree of friendship in real space between the target user and the at least one social media account;

calculating a weight to be assigned to the information by using the offline friend level; and

calculating a score representing possibility of the target user being active at a candidate location on the basis of the information and the weight.

### [Supplementary Note 18]

An activity range estimation method comprising:

calculating an offline friend level on the basis of information obtained from at least one social media account related to a target user having an account in social media, the offline friend level indicating a degree of friendship in real space between the target user and the at least one social media account;

calculating a weight to be assigned to the information by using the offline friend level;

calculating a score representing possibility of the target user being active at a candidate location on the basis of the information and the weight; and

estimating an activity range of the target user on the basis of the score.

### [Supplementary Note 19]

A computer-readable medium storing a program causing a computer to perform a process comprising:

calculating an offline friend level on the basis of information obtained from at least one social media account related to a target user having an account in social media, the offline friend level indicating a degree of friendship in real space between the target user and the at least one social media account;

calculating a weight to be assigned to the information by using the offline friend level; and

calculating a score representing possibility of the target user being active at a candidate location on the basis of the information and the weight.

### [Supplementary Note 20]

A computer-readable medium storing a program causing a computer to perform a process comprising:

calculating an offline friend level on the basis of information obtained from at least one social media account related to a target user having an account in social media, the offline friend level indicating a degree of friendship in real space between the target user and the at least one social media account;

calculating a weight to be assigned to the information by using the offline friend level;

calculating a score representing possibility of the target user being active at a candidate location on the basis of the information and the weight; and

estimating an activity range of the target user on the basis of the score.

### REFERENCE SIGNS LIST

100 ACTIVITY RANGE ESTIMATION APPARATUS
110 USER LOCATION CALCULATION APPARATUS
111 OFFLINE FRIEND DETERMINATION MEANS
112 FRIEND WEIGHT CALCULATION MEANS
113 CANDIDATE LOCATION SCORE CALCULATION MEANS
114 ACTIVE USER DETERMINATION MEANS
120 ACTIVITY RANGE ESTIMATION MEANS
121 KNOWN INFORMATION CHECKING MEANS
130 STORAGE DEVICE
131 USER INFORMATION STORAGE UNIT

What is claimed is:

1. A user location calculation apparatus comprising:
at least one memory storing instructions, and
at least one processor configured to execute the instructions to;
calculate an offline friend level on the basis of first information obtained from at least one social media account related to a target user having an account in social media, the offline friend level indicating a degree of friendship in real space between the target user and the at least one social media account related to the target user;
calculate a weight to be assigned to the first information on the basis of the offline friend level; and
calculate a score representing possibility of the target user being active at a candidate location on the basis of the first information and the weight.

2. The user location calculation apparatus according to claim 1, wherein
the at least one processor further configured to execute the instructions to:
set a value of the weight larger as the offline friend level increases, and
increase impact of the first information on calculation of the score as a value of the weight increases.

3. The user location calculation apparatus according to claim 1, wherein
the at least one processor further configured to execute the instructions to:
determine whether the social media account related to the target user is a local account related to a specific area, and calculate the offline friend level on the basis of a result of the determination.

4. The user location calculation apparatus according to claim 3, wherein
the at least one processor further configured to execute the instructions to:
determine, when it is determined whether the social media account related to the target user is the local account is not clear, whether a social media account related to the social media account related to the target user is the local account on the basis of second information obtained from the social media account related to the social media account related to the target user, and determine whether the social media account related to the target user is the local account by using a result of the determination.

5. The user location calculation apparatus according to claim 4, wherein
the at least one processor further configured to execute the instructions to:
determine that the social media account related to the target user is the local account on the basis of spatial dispersion of areas related to social media accounts related to the social media account determined to be the local account related to the target user.

6. The user location calculation apparatus according to claim 3, wherein
the at least one processor further configured to execute the instructions to:
calculate the offline friend level according to a government level of an area related to the local account.

7. The user location calculation apparatus according to claim 1, wherein
the at least one processor further configured to execute the instructions to:
calculate offline friend level on the basis of an activity range of the social media account related to the target user.

8. The user location calculation apparatus according to claim 7, wherein
the at least one processor further configured to execute the instructions to:
classify social media accounts with known ranges of activities related to the target user into one or more clusters, and calculate the offline friend level according to a proportion of the number of social media accounts belonging to each cluster to the number of the social media accounts with the known ranges of activities related to the target user.

9. The user location calculation apparatus according to claim 1, wherein
the at least one processor further configured to execute the instructions to:
calculate the offline friend level on the basis of whether social media accounts related to the target user are related to each other.

10. The user location calculation apparatus according to claim 1, wherein
the at least one processor further configured to execute the instructions to:
determine whether a social media account related to the target user is a famous account, and calculate the offline friend level on the basis of a result of the determination.

11. The user location calculation apparatus according to claim 1, wherein
the at least one processor further configured to execute the instructions to:
calculate a reliability level of the offline friend level, and
calculate the weight on the basis of the offline friend level and the reliability level.

12. The user location calculation apparatus according to claim 1, wherein:
the at least one processor further configured to execute the instructions to:
determine whether a social media account related to the target user is an account of an active user,
calculate the offline friend level of a social media account related to the target user determined to be an account of an active user.

13. The user location calculation apparatus according to claim 1, wherein:
the at least one processor further configured to execute the instructions to:
refer to a storage device storing the first information and the weight as known information, and determine whether information of a social media account related to the target user is stored in the storage device,
calculate, when it is determined that information of the social media account related to the target user is stored in the storage device, the score by using the first information and the weight read from the storage device.

14.-16. (canceled)

17. A user location calculation method comprising:
calculating an offline friend level on the basis of information obtained from at least one social media account related to a target user having an account in social media, the offline friend level indicating a degree of friendship in real space between the target user and the at least one social media account;
calculating a weight to be assigned to the information by using the offline friend level; and
calculating a score representing possibility of the target user being active at a candidate location on the basis of the information and the weight.

18. (canceled)

19. A non-transitory computer-readable medium storing a program causing a computer to perform a process comprising:
calculating an offline friend level on the basis of information obtained from at least one social media account related to a target user having an account in social media, the offline friend level indicating a degree of friendship in real space between the target user and the at least one social media account;
calculating a weight to be assigned to the information by using the offline friend level; and
calculating a score representing possibility of the target user being active at a candidate location on the basis of the information and the weight.

20. (canceled)

21. The user location calculation apparatus according to claim 1, wherein the at least one social media account is different from the account owned by the target user.

22. The user location calculation apparatus according to claim 1, wherein the at least one processor further configured to execute the instructions to:
estimate an active range of the target user on the basis of the score.
